(19) United States
(12) Patent Application Publication
(10) Pub. No.: US 2006/0289786 A1
(43) Pub. Date: Dec. 28, 2006

(54) System and method for a pulsed light source used in fluorescence detection

(75) Inventors: Roger H. Taylor, San Diego, CA (US); Taylor A. Reid, Carlsbad, CA (US); Howard Y. Choi, San Diego, CA (US)

Correspondence Address: PALMER & DODGE, LLP;KATHLEEN M. WILLIAMS / STR, 111 HUNTINGTON AVENUE, BOSTON, MA, 02199, US

(73) Assignee: Stratagene California

(21) Appl. No.: 11/416,886

(22) Filed: May 2, 2006

Related U.S. Application Data
(60) Provisional application No. 60/677,747, filed on May 4, 2005.

(51) Int. Cl. G01N 21/64; G01J 3/30

(52) U.S. Cl. 250/458.1; 356/318; 356/417

(57) ABSTRACT

A system and method for a pulsed light source used in detecting fluorescence from a plurality of samples of biological material discretely, continuously or intermittently during thermal cycling of DNA to accomplish a polymerase chain reaction (PCR). An apparatus for sampling at least one sample of a biological material comprises a light source that emits a pulsed excitation light that interacts with the sample and a detector sensitive to fluorescence emitted from the sample. A method of sampling at least one sample to detect fluorescence comprises generating a pulsed excitation light with a pulsed light source; directing the pulsed excitation light into the sample; illuminating a sample with the pulsed excitation light to generate an emission light; and detecting the optical characteristics of the emission light.

### RELATED APPLICATIONS

This application claims the benefit of U.S. Provisional Application Ser. No. 60/677,747, filed May 4, 2005, the entirety of which is hereby incorporated herein by reference.

### FIELD

The present invention relates to an apparatus for scanning a plurality of samples, and more particularly to a system and method for a pulsed light source used in fluorescence detection.

### BACKGROUND

Techniques for thermal cycling of DNA samples are known in the art. By performing a polymerase chain reaction (PCR), DNA can be amplified. It is desirable to cycle a specially constituted liquid biological reaction mixture through a specific duration and range of temperatures in order to successfully amplify the DNA in the liquid reaction mixture. Thermocycling is the process of melting DNA, annealing short primers to the resulting single strands, and extending those primers to make new copies of double stranded DNA. The liquid reaction mixture is repeatedly put through this process of melting at high temperatures and annealing and extending at lower temperatures.

In a typical thermocycling apparatus, a biological reaction mixture including DNA will be provided in a large number of sample wells on a thermal block assembly. Quantitative PCR (qPCR) uses fluorogenic probes to sense DNA. Instrumentation designed for qPCR must be able to detect approximately 1 nM of these probes in small volume samples (e.g., approximately 25 μl). The detection method must be compatible with the thermal cycling required for qPCR. The detection method must also be capable of distinguishing multiple fluorogenic probes in the same sample.

Enhancing the sensitivity of fluorescence detection of a qPCR instrument or method improves the usefulness of that instrument or method by enabling detection of DNA sooner, that is, after fewer thermal cycles. Instruments or methods whose sensitivity is limited by non-optical noise (primarily electronics noise) and/or shot noise often benefit from higher intensity light sources. Brighter light sources, however, often are more expensive, require larger power supplies, generate a greater amount of heat that must be dissipated, and have shorter lifetimes.

The prior art includes instruments and methods that use a light source that remains constant. U.S. Pat. No. 6,563,581 to Oldham et al. discloses a system for detecting fluorescence emitted from a plurality of samples in a sample tray. U.S. Pat. No. 6,015,674 to Woudenberg et al. discloses a system for measuring in real time polynucleotide products from nucleic acid amplification processes, such as polymerase chain reaction (PCR).

The sensitivity of prior art systems and methods could be improved through pulsing the light source. Thus, there is a need in the art for an apparatus and method for a pulsed light source for scanning a plurality of samples.

### SUMMARY

A system and method for a pulsed light source used in fluorescence detection are disclosed herein.

According to aspects illustrated herein, there is provided an apparatus for sampling at least one sample of a biological material comprising at least one light source that emits an excitation light at defined intervals, wherein the excitation light interacts with the at least one sample; and a detector sensitive to fluorescence emitted from the at least one sample.

According to aspects illustrated herein, there is provided a system for detecting fluorescence from at least one sample comprising at least one pulsed light source for generating a pulsed excitation light; and at least one detector sensitive to a fluorescence emitted from at least one sample.

According to aspects illustrated herein, there is provided a method of sampling at least one sample to detect fluorescence comprising generating a pulsed excitation light with a pulsed light source; directing the pulsed excitation light into the sample; illuminating the sample with the pulsed excitation light to generate an emission light; and detecting the optical characteristics of the emission light.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is a view of a pulsed light source showing an optical module emitting light when above a sample tube.

FIG. 2 is a view of a pulsed light source showing the optical module not emitting light when between sample tubes.

FIG. 3 is a schematic diagram of a pulse switching circuit of a pulsed light source.

FIG. 4 is a diagram showing pulse timing options for a pulsed light source.

FIG. 5 is a perspective view of a pulsed light source mounted to an assembly that shows the path as the pulsed light source is scanned over a plurality of sample tubes.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

A system and method for a pulsed light source used in detecting fluorescence from a plurality of samples of biological material during thermal cycling of DNA to accomplish a polymerase chain reaction (PCR), a quantitative polymerase chain reaction (qPCR), a reverse transcription-polymerase chain reaction, fluorescence detection or other nucleic acid amplification types of experiments are disclosed herein. The system and method may detect fluorescence discretely, continuously or at intermittent time period intervals during thermal cycling.

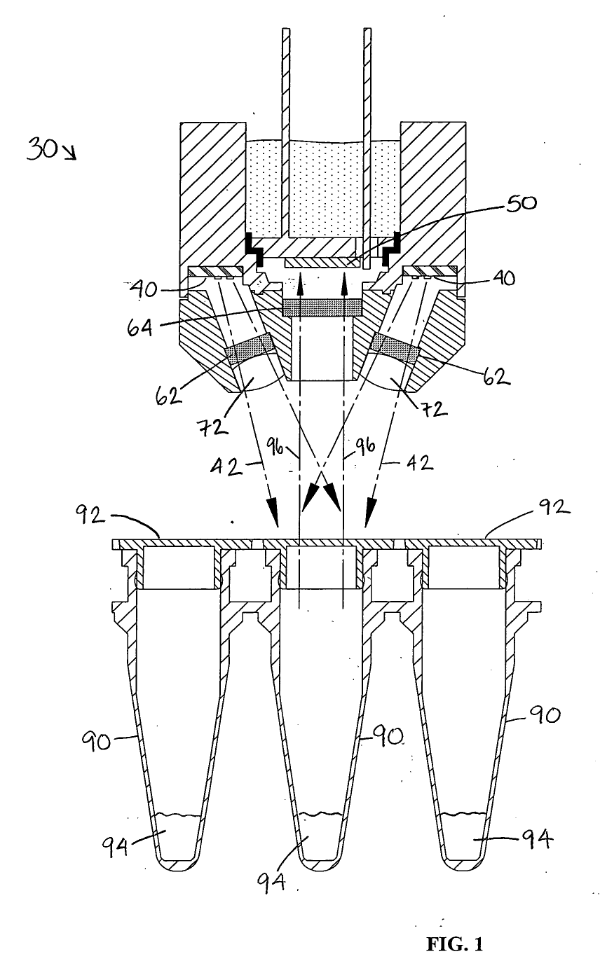

FIG. 1 shows a pulsed light source 30 for scanning a plurality of samples for use in a fluorescence-based system for monitoring in real time the progress of a nucleic acid amplification reaction or reactions. The type of amplification scheme used with the system is not critical, but generally the system requires either the use of a nucleic acid polymerase with exonuclease activity or a population of double stranded DNA that increases during the course of the reaction being monitored.

Thermal cyclers are the programmable heating blocks that control and maintain the temperature of the sample through the temperature-dependent stages that constitute a single cycle of PCR: template denaturation; primer annealing; and primer extension. These temperatures are cycled up to forty times or more to obtain amplification of the DNA target. Thermal cyclers use different technologies to effect temperature change including, but not limited to, peltier heating and cooling, resistance heating, and passive air or water heating.

As used herein, “optical module” refers to the optics of systems for thermal cycling known in the art including, but not limited to, modular optics, non-modular optics, and any other suitable optics. The optical module can be used for scanning a plurality of samples of biological material after thermal cycling of DNA to accomplish a polymerase chain reaction (PCR), discretely, continuously or intermittently during thermal cycling of DNA to accomplish a quantitative polymerase chain reaction (qPCR), after thermal cycling of DNA after a reverse transcriptase reaction to accomplish a reverse transcription-polymerase chain reaction (RT-PCR), discretely, continuously or intermittently during thermal cycling of DNA after a reverse transcriptase reaction to accomplish a reverse transcription-quantitative polymerase chain reaction (RT-qPCR), or for fluorescence detection during other nucleic acid amplification types of experiments.

FIG. 1 shows an illustrative optical module 30 having a pulsed light source for scanning a plurality of samples. The optical module 30 includes a light source 40 for exciting the fluorogenic probes in the qPCR samples. The sensitivity of the fluorescence detection depends on the strength of the illumination. Up to the point that the optical noise is the dominant noise source, increasing the illumination intensity increases the sensitivity of the reading. Increasing the illumination intensity requires more power and more heat dissipation. These requirements can be reduced by pulsing the light source.

The optical module 30 is used for detecting fluorescence from a plurality of samples. The optical module 30 includes at least a light source 40 and a detector 50. The optical module 30 may also include an excitation filter 62 and an emission filter 64. Electronics for powering the light source 40 and measuring the signal from the detector 50 are required, although the electronics may be remotely attached to the optical module 30. The electronics may be under computer control. The optical module 30 may be a single component or composed of a plurality of assembled parts.

The illustrative optical module in FIG. 1 shows the optical module 30 having a pulsed light source 40 emitting light 42 when above one of the plurality of sample tubes 90. In this embodiment, multiple light sources 40 are arrayed on the periphery of the optical module 30, pointed and focused to illuminate the contents of the sample tube. A plurality of light rays 42 are emitted from the light sources 40. The light 42 from each light source 40 travels through an excitation filter 62, then is focused by a lens 72 towards the sample tube 90. The focus is preferably anywhere inside the sample tube 90, but aiming and focusing the light 42 from the light source 40 onto a cap 92 of the sample tube 90 is effective.

The light 42 travels through the cap 92 and into the sample tube 90 where it excites fluorogenic probes typically used in qPCR that are within the sample 94 in the sample tube 92, causing the sample to fluoresce. Emitted fluorescent light 96 from the sample 94 passes through the cap 92, through the emission filter 64 and reaches the detector 50.

A biological probe can be placed in each DNA sample so that the amount of fluorescent light emitted as the DNA strands replicate during each thermal cycle is related to the amount of DNA in the sample. A suitable optical detection system can detect the emission of radiation from the sample. By detecting the amount of emitted fluorescent light 96, the detection system measures the amount of DNA that has been produced. Data can be collected from each sample tube 90 and analyzed by a computer.

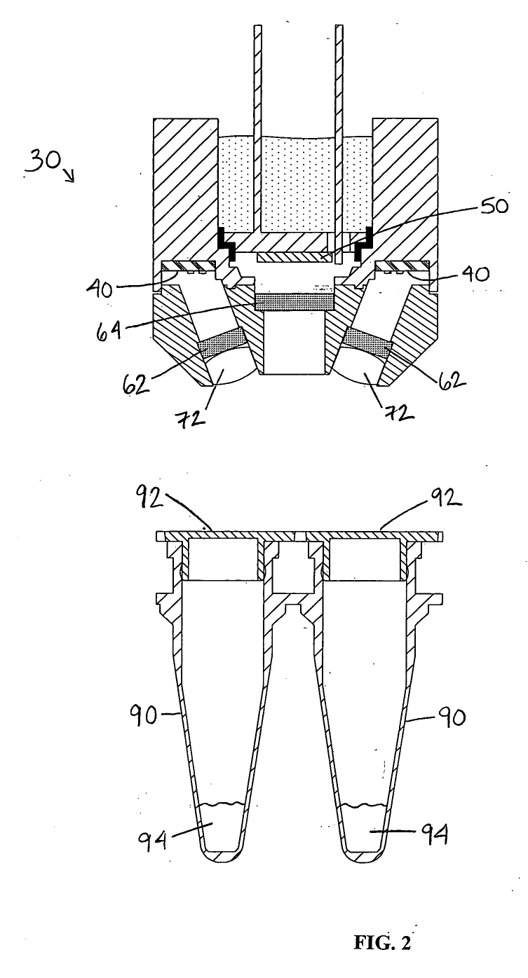

FIG. 2 shows a pulsed light source with the optical module not emitting light when it is between sample tubes. When the pulsed light source is off, no light is emitted from the pulsed light source. Having the light source off when the optical module is not detecting fluorescence from a sample does not affect the sensitivity of the detection of a sample, allows the light source to cool and reduces the total power required for the light source compared to running the light source continuously. The timing of when the pulsed light source is on and off provides an opportunity for optimizing its performance under different circumstances including, but not limited to, row pulsing, sample pulsing, and high frequency pulsing which will be discussed below.

The light source 40 may be broad band or narrow band, and it must be bright enough for the optical module 30 to be able to detect the concentration of probes used in the reaction, for example, qPCR. The light source could be, for example, one or a plurality of LEDs, laser diodes, lasers, or incandescent sources. The duration and frequency of the light pulses should be consistent with the capabilities of the light source. Incandescent sources require longer warm-up time before reaching stability than the other sources, and incandescent sources have longer lifetimes when power to them is cycled smoothly. Incandescent sources could be pulsed at a relatively low frequency and still be useful for qPCR. The low frequency is possible in qPCR because measurement of the samples occurs at only a few or even one time per thermal cycle, and each thermal cycle in typical applications lasts about thirty seconds or more. The lifetimes of the other light sources are much less affected by how abruptly the power is cycled, and other light sources can be pulsed at higher frequencies than those suitable for incandescent sources without appreciably degrading their performance.

Within each kind of light source, different capabilities may be available that also require consideration. For example, some lasers have pulsewidths on the order of 10 fs while others have pulses no shorter than 10 ns. These pulsewidths may be useful for high frequency pulsing or for lock-in detection (each described below). In either of these applications, the detection electronics must be designed based on the pulsing frequency. The pulsewidth should be greater than the time constant of the electronics.

A light emitting diode (LED) or a plurality of LEDs are particularly suited as a pulsed light source 40 because LEDs stabilize very quickly once current is applied to them and their pulse frequencies and durations can be controlled over ranges of values. An LED is a semiconductor device that emits light through electroluminescence. An LED is a special type of semiconductor diode. Like a normal diode, an LED consists of a chip of semiconducting material impregnated, or doped, with impurities to create a structure called a pn junction. Charge-carriers (electrons and holes) are created by an electric current passing through the junction. When an electron meets a hole, it falls into a lower energy level, and releases energy in the form of light.

LEDs emit incoherent quasi-monochromatic light when electrically biased in the forward direction. The color of light emitted depends on the semiconducting material used and can be near-ultraviolet, visible, or infrared. The wavelength of the light emitted, and therefore its color, depends on the bandgap energy of the materials forming the pn junction. A normal diode, typically made of silicon or germanium, emits invisible far-infrared light, but the materials used for an LED have bandgap energies corresponding to near-infrared, visible, or near-ultraviolet light.

The detector 50 is capable of detecting the fluorescence from the fluorogenic probes in the sample by converting that fluorescence to a voltage. The detector could be, for example, a photodiode, avalanche photodiode (APD), photomultiplier tube (PMT), or charge-coupled device (CCD). Photodiodes tend to be the smallest and least expensive detection methods. Avalanche photodiodes typically have faster responses to signals than photodiodes but require higher voltages to operate and are more expensive. Of all these detectors, photomultiplier tubes are typically the most sensitive and the most expensive, and they require the highest voltage power supplies. Charge-coupled devices have sensitivity comparable to photodiodes, they provide spatial resolution to the detected light, and they are more expensive than photodiodes. In choosing a detector for use with a pulsed light source, the detector and its electronics should respond quickly enough to the pulsing so that the benefits of pulsing are not lost. If the electronics and detector cannot recover fully between pulses, then pulsing the light source provides little improvement of the sensitivity of the system.

If used, the filters 62, 64 are preferably narrow band-pass filters that attenuate frequencies above and below a particular band. The filters are preferably a matched pair of filters, consisting of an excitation filter 62 and an emission filter 64. The excitation filter 62 transmits light that excites a particular fluorogenic probe of interest and effectively blocks light that excites other probes. The emission filter 64 transmits light from the same, excited fluorgenic probe efficiently, but blocks light from other probes effectively. The specifications of the filters depend on the light source. For example, because an incandescent source has a broader spectrum than an LED source, the filters used with an incandescent source would need to attenuate a larger range of wavelengths than the filters used with an LED source.

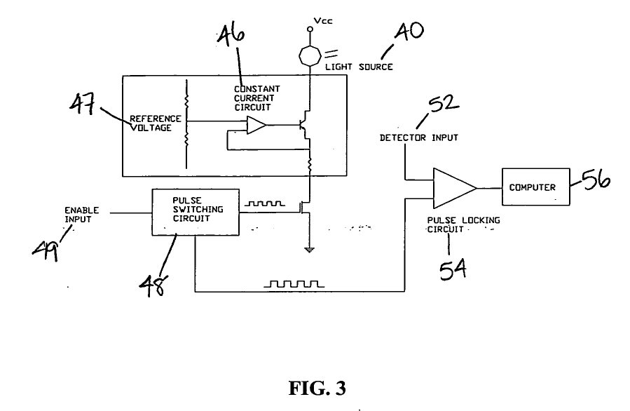

The electronics powers the light source 40 and converts the signal from the detector 50 into a number that may be human or computer readable. FIG. 3 is a schematic diagram of a pulse switching circuit of a pulsed light source. To pulse the light source 40, the current supplied to the light source is pulsed. Because fluctuations in the light source add to the noise in the detected signal, care should be taken so that every pulse has very nearly the same brightness. Noise on the current driving the light source can be a significant source of fluctuations in the light source, so the current driving the light source should be held constant. This goal is achieved in the schematic diagram shown in FIG. 3 through the use of a constant current circuit 46. The constant current circuit 46 uses a reference voltage 47 that is stable to keep current variation low.

The constant current circuit 46 produces pulsed light by sending current pulses to power the light source 40. The current pulses are defined and controlled by a pulse switching circuit 48. An enable input 49 is used if a sensor controls whether the pulse switching circuit is operating (for example, a sensor that detects when the optical module is scanning a row). The pulsing from this circuit can come from either analog or digital control. An analog circuit for controlling the pulses consists of passive electronics components, switches, and/or relays. A digital circuit uses programmed instructions from, for example, a field programmable gate array (FPGA), digital signal processing chip (DSP), and/or computer program to control the pulsing. The digital control provides better flexibility for testing and optimizing the pulse width and frequency, whereas analog control may be less expensive and reach higher frequencies. At low frequencies (for example, for row pulsing and sample pulsing described below), a light source can be pulsed by analog or digital control. Digital signals from a processor can provide electronic pulses that a current source can use to control its output. At higher frequencies, digital control may not be able to provide fast enough pulses. To pulse at these frequencies, analog oscillators may be required.

At high frequencies, the sensitivity may be enhanced by using lock-in detection. Lock-in detection preferentially amplifies signals at a defined frequency. This amplification is exemplified schematically in FIG. 3 as occurring in a pulse locking circuit 54. The pulse locking circuit 54 compares the signal from the detector (detector input 52 ) to the pulse train coming from the pulse switching circuit 48, which is synchronous with the pulses that control the current to the light source 40. The pulse locking circuit 54 amplifies detector input 52 signals from the detector 50 at the same frequency as the pulse train from the pulse switching circuit 48 highly preferentially compared to signals at any other frequency. The amplified signal is sent from the pulse locking circuit 54 to a computer 56 for conversion of the signal voltage to a numerical value and other analysis. The pulse locking circuit 54 and the pulse train to the pulse locking circuit 54 are used only for high frequency pulsing.

When optical noise is not the limitation on the sensitivity, pulsing the illumination from the light source 40 can increase the sensitivity of the optical module 30. More light on the sample results in greater signal from the sample. As long as increasing the light does not also increase the noise proportionately, then more light results in greater sensitivity. Limits on the brightness of light sources are often set by limits on the temperatures the light sources can withstand because running a light source at a higher output (brighter) often results in a higher operating temperature. Because a light source cools when it is off, turning the light source 40 on only when the detector 50 is sensing the fluorescence of a sample allows the light to be brighter during measurement than if the light is on continuously. The temperature rise of a light source, ΔT, can be calculated by noting that at steady state, the energy into the light source equals the energy dissipated by the light source. The energy into the light source is given by the equation:
k_{I} ∫P(t)dt=k_{I}R ∫I²(t)dt

where k_{I}, is a constant depending on the light source, P(t) is the power into the light source as a function of time, R is the electrical resistance of the light source, I²(t) is the square of the current supplied to the light source as a function of time, and the integration is over the period of the pulses.

The energy dissipated by the light source is:
kₑΔT
where kₑ is a constant that depends on the light source and its relation to its environment and ΔT is the difference in temperature between the light source and its environment.

Equating these terms and solving for the temperature rise shows that the temperature rise is proportional to the square of the average current into the light source:

$$Δ T = \frac{{k}_{I} R}{{k}_{e}} \int {I}^{2} ( t ) ⅆ t ∝ \int {I}^{2} ( t ) ⅆ t$$

Because, in this approximation, the current is time-averaged, the actual temporal profile of the current driving the light source is not relevant, so that the profile can be optimized to produce the highest signal while keeping its time-averaged value at the level that produces the maximum allowed temperature rise. When the sensitivity of the optical module is not limited by noise from the light source, the profile is optimized when the average current is the value that gives the maximum permitted temperature rise and the light source is brightest while the measurement is made and off at all other times.

Optimizing the intensity of the light source for the highest sensitivity is benefited by understanding the sources of noise. At low light levels, both the detection and electronics noise limit the sensitivity. When the light source is off (FIG. 2), no signal is detected, only noise. This noise is independent of light intensity. Turning the light source on increases the light intensity and the signal from the optical module 30, and results in greater sensitivity of the optical module 30 because the amount of noise remains relatively constant. At some light intensity level, noise sources related to the light intensity will become larger than the detection and electronics noise. Some of the noise sources are proportional to the light intensity, some proportional to the square root of the light intensity. The sensitivity will continue to grow with increasing light intensity until the noise sources proportional to the light intensity comprise the largest component of the noise. The proportional noise sources typically result from the process of generating the light and often result from noise in the current used to drive the light source.

The light intensity should be raised as high as possible before the sensitivity of the optical module no longer increases. Careful characterization of the noise sources provides a means to predict the optimum light intensity, but experimentation is generally required to finish the optimization because approximations and assumptions that cannot be confirmed are often required when characterizing the noise. This method of optimizing the intensity of the light source works whether the light source is always on or it is pulsed.

Pulsing the light source provides other benefits as well. When multiple optical modules are used for multiplexing applications (detection of different fluorogenic probes from the same sample), scattered light from one module can reach another module and thereby increase its background and reduce its sensitivity. Pulsing provides an opportunity to temporally stagger the light from different colored sources that are tuned to different fluorophores. Timing the pulses so that only one module is on and detecting signal from a sample at a time eliminates the problem of scattering from one module into another and increases the combinations of fluorophores that can attain optimal performance, including pairs of fluorophores, one of which has an excitation wavelength close to or the same as the emission wavelength of the other.

Pulsing may be beneficial in qPCR applications also because pulsing the light source allows for the possibility of lock-in detection. Lock-in detection enhances sensitivity by amplifying signals only at the pulse frequency; noise and/or signals at other frequencies are not amplified. Noise in a system consists of spurious signals over a range of frequencies. Lock-in detection is a method for reducing the effects of the spurious signals by detecting signals over only a narrow range of frequencies so that spurious signals and therefore noise outside that frequency range are attenuated. In particular, when the light source in a qPCR instrument is pulsed, the signal from the samples will have the same frequency as the pulses from the light source. Lock-in detection that amplifies signals at that frequency but attenuates all other frequencies helps to reduce the noise of the system and thereby improve its sensitivity.

The pulse rate should be optimized so that the light source is on and stable during the measurement and off for as long as possible. For a light source used in an optical system that scans samples (for example, by physically moving the optical module over the samples or by otherwise sequentially collecting fluorescence from the samples), the light source should be on while the module is in position to illuminate and collect fluorescence from a sample. The light source should be off at all other times, to the extent allowed by other design constraints including, but not limited to, warm-up time, the noise of the electronics, and the cost of the system.

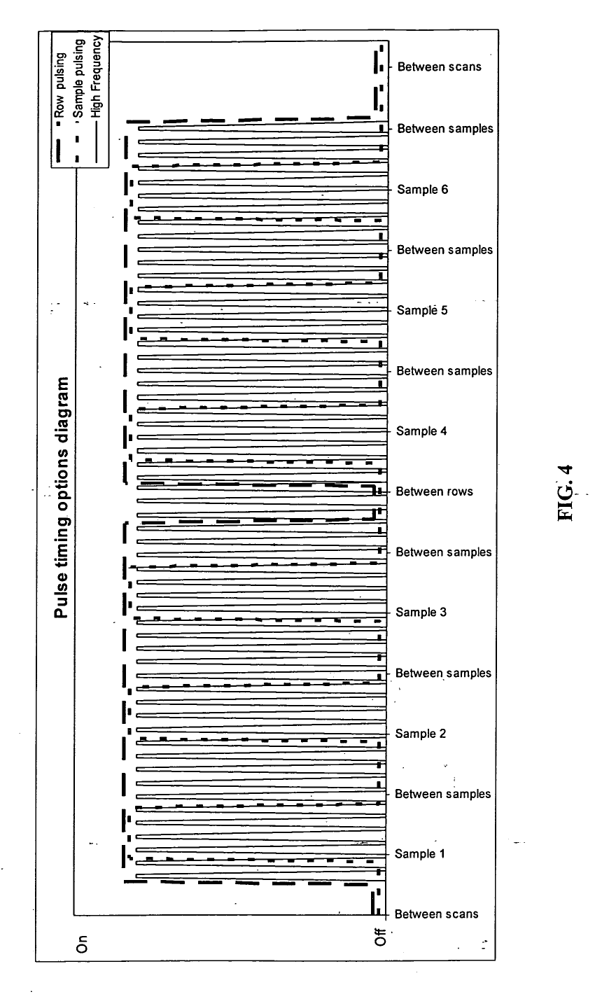

FIG. 4 is diagram showing pulse timing options for a pulsed light source. FIG. 4 schematically shows timing possibilities for different pulsing schemes including (1) row pulsing; (2) sample pulsing; and (3) high frequency pulsing. The horizontal axis represents elapsed time, labeled by the location the optical module is above. The vertical axis indicates whether the light source is on or off, with the scales for each pulse train offset from each other for clarity. The sample configuration used for illustrative purposes is a three by two rectangle, although other arrangements and numbers of samples are within the spirit and scope of the invention.

In FIG. 4, the row pulsing (indicated by the dashed line) shows the light source is on from just before to just after the optical module is over each row and off at other times (for example, between rows and between scans). For an optical module scanning a rectangular array of samples, a basic pulsing scheme includes having the light source on while the module is scanning over a row of samples (row pulsing) and off when the module has not reached the first sample of the row, has passed the last sample of the row, is moving from row to row, or is in between scans. Row pulsing minimizes the cost and the electronics noise by requiring only low frequency switching of the light source.

In FIG. 4, the sample pulsing (indicated by the dotted line) shows the light source is on from just before to just after the optical module is over each sample and off at other times (for example, between samples, between rows, and between scans). The scanning module can have the light source on only while the module is over a sample (sample pulsing), then off while it is moving between samples, has not reached the first sample of the row, has passed the last sample of the row, is moving from row to row, or is in between scans. Sample pulsing requires higher frequency pulsing than row pulsing because a scan traverses more samples than rows. The higher frequency requires more complex electronics and more attention to the coordination of the scanning motion and the pulsing to make sure the pulses occur while the optical module is in position to probe a sample's fluorescence. All of these factors may raise the difficulty and cost of sample pulsing compared to row pulsing. In addition, higher frequency pulsing increases the electronics noise, which may decrease the sensitivity of the optical module.

The light source could also pulse faster still (high frequency pulsing), so that the light source is both on and off many times (more than about three) while the module is over the sample. In FIG. 4, the high frequency pulsing (indicated by the solid line) shows the light source on only while scanning during which it is pulsed continuously at a frequency that produces four pulses of light for each sample. Other high frequency pulsing patterns are within the spirit and scope of the invention including leaving the pulse rate constant throughout the entire experiment (even between scans) and using other envelopes (such as row pulsing or sample pulsing) for defining when the high frequency pulsing must be enabled and when the light source must be off. The high frequency pulsing is more complex and more expensive. In addition, high frequency pulsing requires more attention to making sure the signal from the detector is sampled while the light source is on.

These considerations also apply for a light source in an optical system that does not scan across the samples (for example, illumination of and detection from all the samples simultaneously known as flood illumination). In that case, the light should be on only during the measurement. Higher pulse rates can be used to increase the peak power or allow lock-in detection.

It is beneficial to synchronize the measurement and pulsing. For row pulsing, little synchronization between the measurement and the pulses is required. Measurement sample rates can be easily set so that they are high relative to scanning speeds. Sample rates and electronics time constants should be set so that measurements are made for as much of the time the module is over a sample as possible.

As the frequency of the pulsing increases, more care is required to make sure the measurement of the samples collects as much information as possible from the samples. For sample pulsing, the measurement sample rate and electronics time constants can be set with the same basic guidelines as for row pulsing. At higher frequencies, the measurement must be made while the fluorescence from the sample created by the light source illumination is detectable. To make this measurement, the signal from the detector should be measured while the light source is on, preferably near the end of a pulse. This synchronization can be achieved by triggering the current to the light source slightly before triggering the sampling of the detector. Alternatively, two pulse trains can be generated slightly out of phase from each other at the desired pulse frequency by digital electronics, for example. These pulse trains could be used to control the power to the light source and the sampling of the detector.

Coupled into all this synchronization is the electronics time constant, which is the time during which signals are electronically added. This time constant can be controlled, generally using passive electronics components such as resistors and capacitors, and should be coordinated with the measurement sample rate so that measurements are taken at about the same period as the time constant.

If the warm-up time is a problem for a particular pulsing scheme, it needs to be accounted for by making sure the light source is on for longer than the warm-up time before measurement of the sample occurs. Accounting for the warm-up time is more of a problem as the pulse rates are increased because at higher pulse rates, the warm-up time takes up a higher percentage of the time the light source is on.

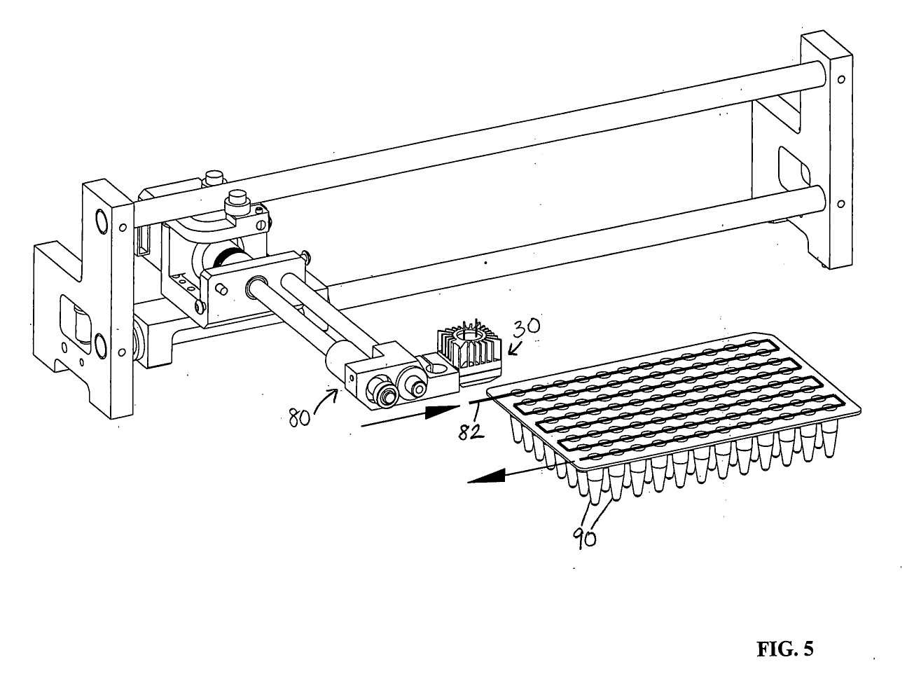

As shown in FIG. 5, the optical module 30 can be used for scanning over the samples of a 96 well (8×12 array) thermal cycler that allows optical access to the samples through a cap. FIG. 5 shows a serpentine method for scanning an optical module over an array of samples. The optical module 30 is shown attached to a two-axis motion system 80 that can be controlled by a computer. The path 82 traversed by the optical module 30 can be defined by blind stepping (driving the axes for predefined time periods). Alternatively, the path 82 can be defined through feedback from a sensor or sensors (not shown). Such sensors could be, for example, scales used for measuring the absolute position of the optical module 30 or limit switches set to sense when the optical module 30 is over or at the end of a particular row or column. The path 82 is serpentine and takes the optical module 30 along each row of samples, starting to the left of the left-most sample of a row and ending to the right of the right-most sample of every other row. The motion system 80 then moves the optical module 30 to the next row before scanning the optical module 30 in the opposite direction as the previous row. Although FIG. 5 shows the optical module path over a 96 well thermal cycler, those skilled in the art will recognize that 48 well, 384 well, 1536 well, and other multiple well thermal cyclers are within the spirit and scope of the invention.

The pulsed light source can be used with thermal cyclers of various makes and models, and is not limited to use in an optical module as exemplified in FIGS. 1- 5. Other thermal cycler systems and methods of detecting the fluorescence from a qPCR reaction could also benefit from a pulsed light source. For example, the pulsed light source could be used with the apparatus for thermally cycling samples of biological material described in assignee's U.S. Pat. No. 6,657,169, and the entirety of this patent is hereby incorporated herein by reference. The pulsed light source can also be used with the Mx3000P Real-Time PCR System and the Mx4000 Multiplex Quantitative PCR System (commercially available from Stratagene California in La Jolla, Calif.) using a tungsten halogen bulb that sequentially probes each sample, detected with a photomultiplier tube. In addition, the pulsed light source could be used with thermal cyclers incorporating any or all of the following: a tungsten halogen bulb that sequentially probes each sample; a scanning optical module; stationary LEDs for each well and the same detector for all wells; stationary samples, light sources, and detectors; stationary LEDs and a detector to probe spinning samples sequentially; a tungsten halogen bulb to illuminate the entire plate and a CCD detection of the entire plate; a stationary light source and multiple detectors sampling spinning capillaries sequentially; a stationary laser and detector that sequentially probes stationary samples using independent fiber optics collecting light from each sample; a tungsten halogen bulb to illuminate the entire plate and CCD detection of the entire plate, and other thermal cyclers known in the art.

The samples of biological material are typically contained in a plurality of sample tubes. The sample tubes are available in three common forms: single tubes; strips of eight tubes which are attached to one another; and tube trays with 96 attached sample tubes. The optical module 30 is preferably designed to be compatible with any of these three designs.

Each sample tube may also have a corresponding cap for maintaining the biological reaction mixture in the sample tube. The caps are typically inserted inside the top cylindrical surface of the sample tube. The caps are relatively clear so that light can be transmitted through the cap. Similar to the sample tubes, the caps are typically made of molded polypropylene, however, other suitable materials are acceptable. Each cap has a thin, flat, plastic optical window on the top surface of the cap. The optical window in each cap allows radiation such as excitation light to be transmitted to the fluorogenic probes in the samples and emitted fluorescent light from the fluorogenic probes in the samples to be transmitted back to an optical detection system during cycling.

Other sample holding structures such as slides, partitions, beads, channels, reaction chambers, vessels, surfaces, or any other suitable device for holding a sample can be used with the invention. The samples to be placed in the sample holding structure are not limited to biological reaction mixtures. Samples could include any type of cells, tissues, microorganisms or non-biological materials.

The pulsed light source can be used for detecting fluorescence in other biological applications including, but not limited to, green fluorescent protein, DNA microarray chips, protein microarray chips, flow cytometry, and similar reactions known to those skilled in the art.

A method of sampling at least one sample to detect fluorescence comprises generating a pulsed excitation light with a pulsed light source; directing the pulsed excitation light into the sample; illuminating the sample with the pulsed excitation light to generate an emission light; and detecting the optical characteristics of the emission light.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for sampling at least one sample of a biological material comprising:
at least one light source that emits an excitation light at defined intervals, wherein the excitation light interacts with the at least one sample; and
a detector sensitive to fluorescence emitted from the at least one sample.

2. The apparatus of claim 1 wherein the excitation light is pulsed to minimize scattering from an optical module into another optical module.

3. The apparatus of claim 1 wherein a signal from the detector at a pulse frequency of the light source is amplified.

4. The apparatus of claim 1 further comprising an optical module that houses the at least one light source.

5. The apparatus of claim 1 wherein the light source comprises a light emitting diode.

6. The apparatus of claim 1 wherein the light source comprises a tungsten halogen bulb.

7. The apparatus of claim 1 wherein the light source comprises a laser.

8. The apparatus of claim 1 further comprising an analog circuit to control a pulsing of the light source.

9. The apparatus of claim 1 further comprising a digital circuit to control a pulsing of the light source.

10. The apparatus of claim 1 wherein the detector comprises a charge-coupled device.

11. The apparatus of claim 1 wherein the detector comprises a photodiode.

12. The apparatus of claim 1 wherein the detector comprises a photomultiplier.

13. The apparatus of claim 1 wherein the detector comprises an avalanche photodiode.

14. A system for detecting fluorescence from at least one sample comprising:
at least one pulsed light source for generating a pulsed excitation light; and
at least one detector sensitive to a fluorescence emitted from at least one sample.

15. The system of claim 14 further comprising an optical module that houses at least one pulsed light source.

16. The system of claim 14 wherein the pulsed light source is on while an optical module is over a row of samples and off at other times.

17. The system of claim 14 wherein the pulsed light source is on while an optical module is detecting fluorescence from a sample and off at other times.

18. The system of claim 14 further comprising an analog circuit to control a pulsing of the pulsed light source.

19. The system of claim 14 further comprising a digital circuit to control a pulsing of the pulsed light source.

20. The system of claim 14 further comprising a circuitry to amplify signals at a specific frequency.

21. A method of sampling at least one sample to detect fluorescence comprising:
generating a pulsed excitation light with a pulsed light source;
directing the pulsed excitation light into the sample;
illuminating the sample with the pulsed excitation light to generate an emission light; and
detecting the optical characteristics of the emission light.

22. The method of claim 21 further comprising moving an optical module housing a pulsed light source over the sample.

23. The method of claim 21 further comprising activating the pulsed light source while an optical module is over a row of the at least one samples and de-activating the pulsed light source at other times.

24. The method of claim 21 further comprising activating the pulsed light source while an optical module is over a sample and de-activating the pulsed light source at other times.

25. The method of claim 21 further comprising amplifying the detection of the emission light at a pulse frequency of the light source.

26. The method of claim 21 further comprising controlling a pulsing of the pulsed light source by an analog circuit.

27. The method of claim 21 further comprising controlling a pulsing of the pulsed light source by a digital circuit.
